(19) United States
(12) Patent Application Publication
(10) Pub. No.: US 2015/0159921 A1
(43) Pub. Date: Jun. 11, 2015

(54) CRYOCOOLER FOR NOISE AND VIBRATION REDUCTION AND CRYOPUMP INCLUDING THE SAME

(71) Applicant: GVT Co., Ltd., Pyeongtaek (KR)

(72) Inventors: Dongju Lee, Pyeongtaek (KR); Myunghee Han, Pyeongtaek (KR)

(21) Appl. No.: 14/555,900

(22) Filed: Nov. 28, 2014

(30) Foreign Application Priority Data
Dec. 11, 2013 (KR) 10-2013-0153675

(51) Int. Cl. F25B 9/14; B01D 8/00

(52) U.S. Cl. CPC F25B 9/14; B01D 8/00

(57) ABSTRACT

Disclosed herein are a cryocooler for noise and vibration reduction, which is used to create a high to ultrahigh vacuum environment, and a cryopump including the same. The cryocooler for producing a cryogenic temperature by expanding a refrigerant gas includes a cooler main body having a receiving space, a cylinder main body connected to the cooler main body and having a receiving space, a motor received in the cooler main body, a reciprocator received in the cylinder main body and connected to the motor to move linearly by rotary motion of the motor, an inlet valve received in the cooler main body and connected to a compressor to introduce a refrigerant gas into the cylinder main body, an outlet valve received in the cooler main body and connected to the compressor to discharge the refrigerant gas from the cylinder main body, and an inlet diffuser disposed at a front or rear end of the inlet valve and having a plurality of openings, wherein the refrigerant gas is introduced into the cylinder main body through the inlet diffuser when the inlet valve is open, and the openings of the inlet diffuser have a diameter of 1 mm or less. As such, the cryocooler can be applied to manufacturing fields requiring sensitive working environments by reducing noise and vibration generated during periodic repetition of high and low pressures by a refrigeration cycle in a cryopump.

### CROSS REFERENCE RELATED APPLICATION

This application claims foreign priority of Korean Patent Application No. 10-2013-0153675, filed on Dec. 11, 2013, which is incorporated by reference in its entirety into this application.

### BACKGROUND

1. Technical Field

The disclosure relates to a cryocooler for noise and vibration reduction, which is used to create a high to ultrahigh vacuum environment, and a cryopump including the same.

2. Description of the Related Art

Cryopumps are used to create a high to ultrahigh vacuum environment in a variety of industrial fields including semiconductor manufacturing. Cryopumps decrease the inner temperature thereof to an absolute temperature of 8 K (about −265° C.) so that gas molecules lose momentum and thus are condensed or captured, thereby creating a vacuum.

Although using a general refrigeration cycle, cryopumps are characterized in that hydrogen (H₂) or helium (He) is used as a refrigerant. Like general cooling systems of air conditioners, cryopumps basically include a pump main body serving as an indoor unit and a compressor serving as an outdoor unit. In addition, a monitor for measuring temperature is additionally used in cryopumps.

FIG. 1 shows a cryopump in the related art.

The cryopump includes a pump body 10 and a cryocooler 20 connected to the pump body 10 through a flange. The cryocooler 20 is connected to a compressor 40 through a hose 30.

The cryocooler 20 is connected to a first array 22 having a chamber shape, and a baffle 23 is disposed at an upper end of the first array 22. A second array 24 connected to an upper end of the cryocooler 20 is placed in the first array 22.

Through a gate valve 2, the pump body 10 is connected to a process chamber 10 requiring a vacuum. With the gate valve 2 open, the cryopump can create a high to ultrahigh vacuum inside the process chamber 1.

The first array 22 is maintained at a temperature of about 30K to 80K, and the second array 24 is cooled to a temperature of 10 K to condense or adsorb type II gases such as Ar, N₂, and O₂. Type III gases, such as H₂ and Ne, are adsorbed by an active carbon attached to the second array 24.

A refrigerant gas (e.g., helium) compressed in the compressor 40 is supplied to the cryocooler 20 through the hose 30 and then cooled while expanding in the cryocooler 20. This is referred to as the G-M refrigeration principle. Individual components of the cryocooler are cooled to a cryogenic temperature, and the low-pressure refrigerant gas is subjected to heat exchange in an inner reciprocator according to the G-M refrigeration principle and then collected in the compressor through the hose 30.

Valves and the reciprocator placed in the cryocooler 20 cause periodic repetition of high and low pressures in the cryocooler 20, thereby generating noise and vibration of a predetermined frequency. Such noise and vibration is transmitted to the pump body 10 through a flange 21 of the cryocooler 20 and a flange 11 of the pump body 10.

The pump body 10 is connected to the process chamber 1 through the gate valve 2, and therefore the vibration transmitted from the cryocooler 20 to the pump body 10 may be easily transferred to the process chamber 1.

Such noise and vibration may have a negative effect in fields requiring high precision and working environments sensitive to noise and vibration. Therefore, there is a need for units capable of reducing noise and vibration generated in the cryopump.

### BRIEF SUMMARY

The disclosure is conceived to solve such problems in the related art, and an aspect of the disclosure is to provide a cryocooler for noise and vibration reduction which can reduce noise and vibration generated during periodic repetition of high and low pressures in a process of circulating a refrigerant gas by a refrigeration cycle in a cryopump, and a cryopump including the same.

In accordance with one aspect of the disclosure, a cryocooler for producing a cryogenic temperature by expanding a refrigerant gas includes: a cooler main body having a receiving space; a cylinder main body connected to the cooler main body and having a receiving space; a motor received in the cooler main body; a reciprocator received in the cylinder main body and connected to the motor to move linearly by rotary motion of the motor; an inlet valve received in the cooler main body and connected to a compressor to introduce a refrigerant gas into the cylinder main body; an outlet valve received in the cooler main body and connected to the compressor to discharge the refrigerant gas from the cylinder main body; and an inlet diffuser disposed at a front or rear end of the inlet valve and having a plurality of openings, wherein the refrigerant gas is introduced into the cylinder main body through the inlet diffuser when the inlet valve is open, and the openings of the inlet diffuser have a diameter of 1 mm or less.

The cryocooler may further include an outlet diffuser disposed at the front or rear end of the outlet valve and having a plurality of openings, wherein the refrigerant gas may be discharged from the cylinder main body through the outlet diffuser when the outlet valve is open.

The inlet diffuser may be formed of a mesh net of 80 to 250 mesh.

The cryocooler may further include a valve plate disposed above the inlet diffuser and having a plurality of openings allowing the refrigerant gas to flow into the cylinder main body therethrough, wherein the openings of the valve plate may be five to thirty times as large as those of the inlet diffuser.

The inlet diffuser may be disposed in a recess formed in the valve plate.

In accordance with another aspect of the disclosure, a cryopump includes: the cryocooler according to any one of claims 1 to 5; a pump body having a receiving space and connected to the cryocooler; and a compressor supplying a refrigerant gas to the cryocooler and recompressing the refrigerant gas returning from the cryocooler.

Embodiments of the disclosure provide a cryocooler for noise and vibration reduction which can be applied to manufacturing fields requiring sensitive working environments by reducing noise and vibration generated during periodic repetition of high and low pressures by a refrigeration cycle in a cryopump, and a cryopump including the same.

### BRIEF DESCRIPTION OF THE DRAWINGS

The above and other aspects, features and advantages of the disclosure will become apparent from the following description of embodiments given in conjunction with the accompanying drawings, in which:

FIG. 1 shows a cryopump in the related art;

FIG. 2 shows a cryopump according to one embodiment of the disclosure;

FIG. 3 shows a cryocooler according to one embodiment of the disclosure;

FIG. 4 shows a state in which a refrigerant gas flows into a cylinder main body through an inlet valve in the cryocooler shown in FIG. 3;

FIG. 5 shows a state in which the refrigerant gas flows out of the cylinder main body through an outlet valve in the cryocooler shown in FIG. 3;

FIG. 6 is a graph showing sound intensity versus frequency for cryocoolers according to the related art and the embodiment of the disclosure;

FIG. 7 shows sensor positions in vibration tests conducted in cryopumps according to the related art and the embodiment of the disclosure; and

FIG. 8 shows an inlet diffuser according to one embodiment of the disclosure.

### DETAILED DESCRIPTION

Hereinafter, exemplary embodiments of the disclosure will be described in detail with reference to the accompanying drawings. It should be noted that, in assignment of reference numerals to components of each drawing, like components are denoted by like reference numerals throughout the accompanying drawings.

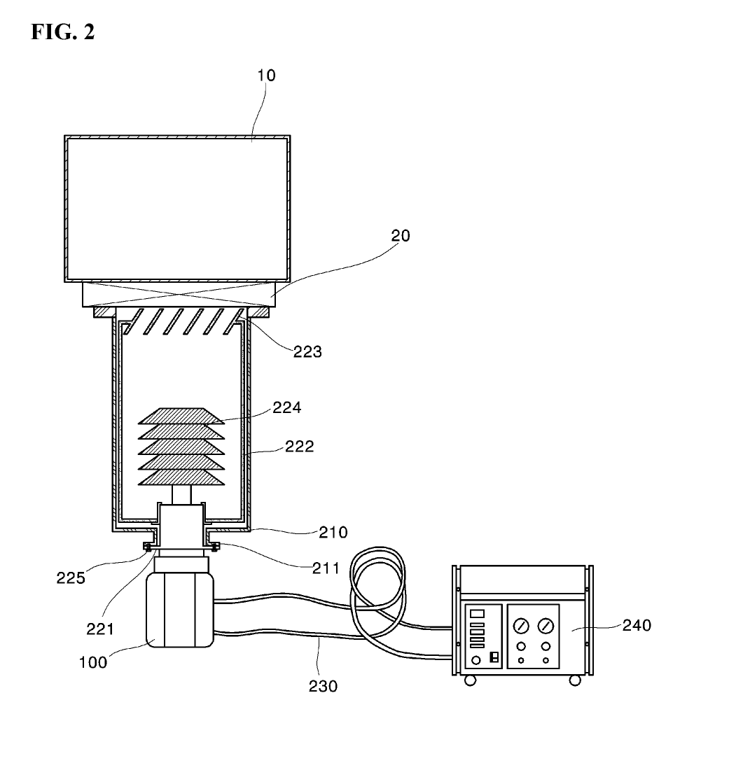

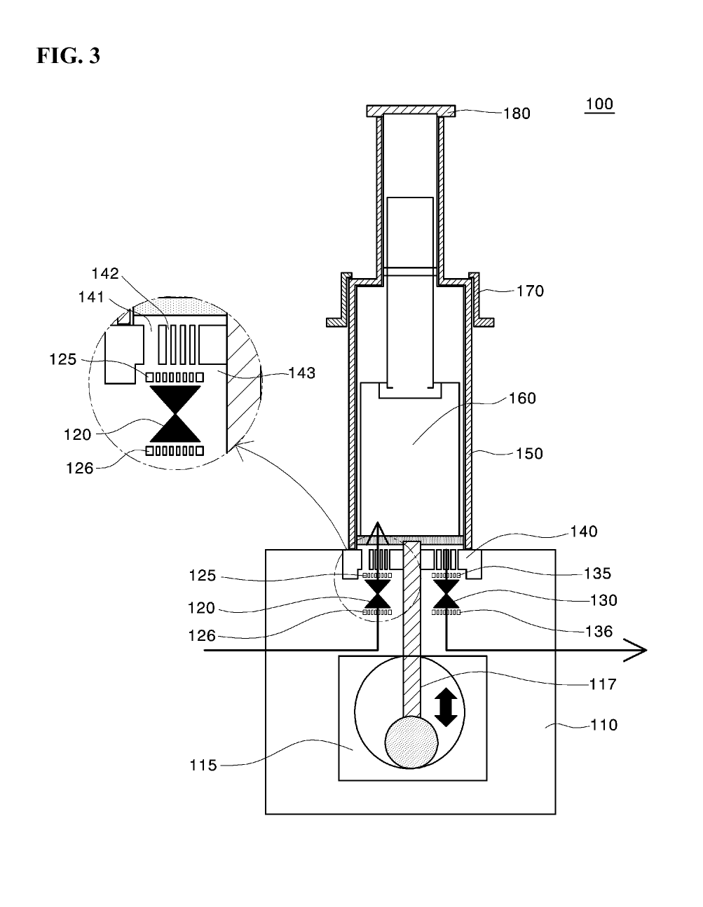

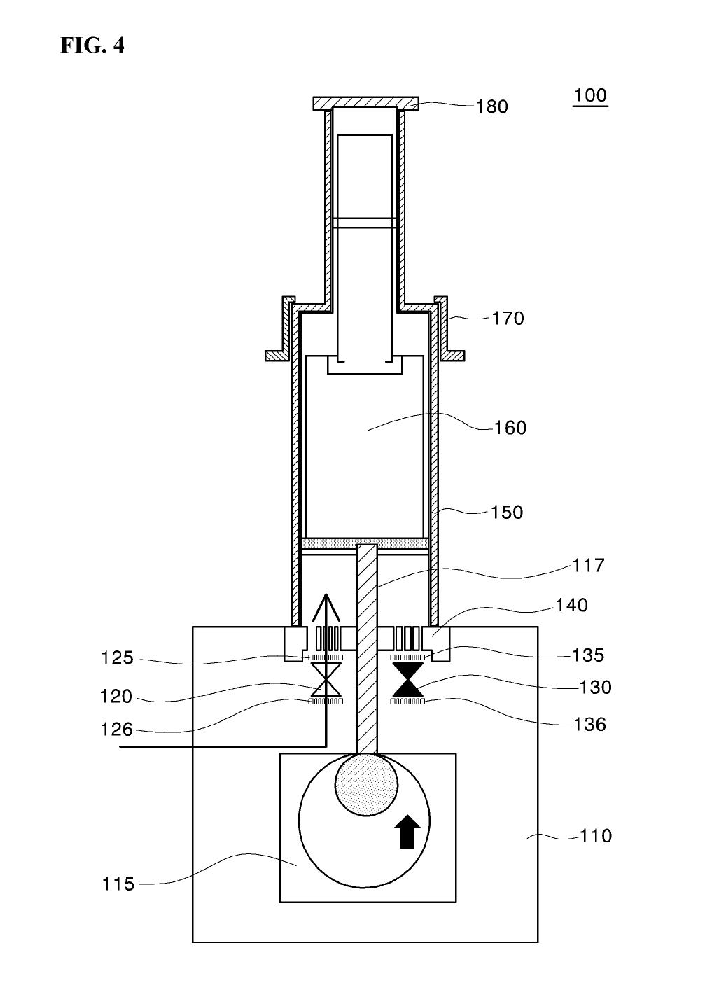

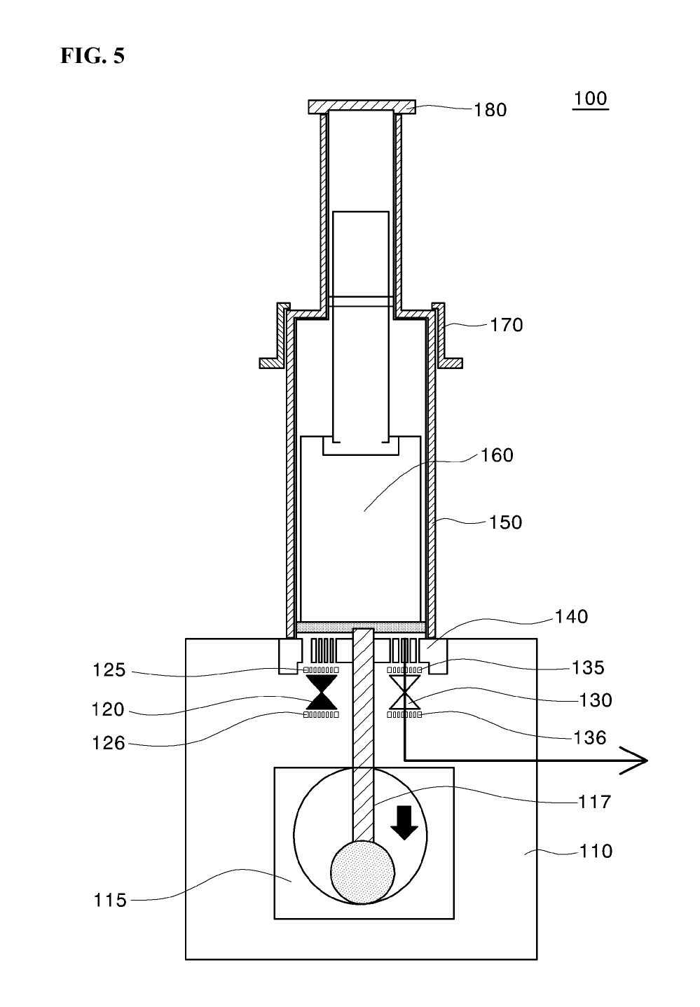

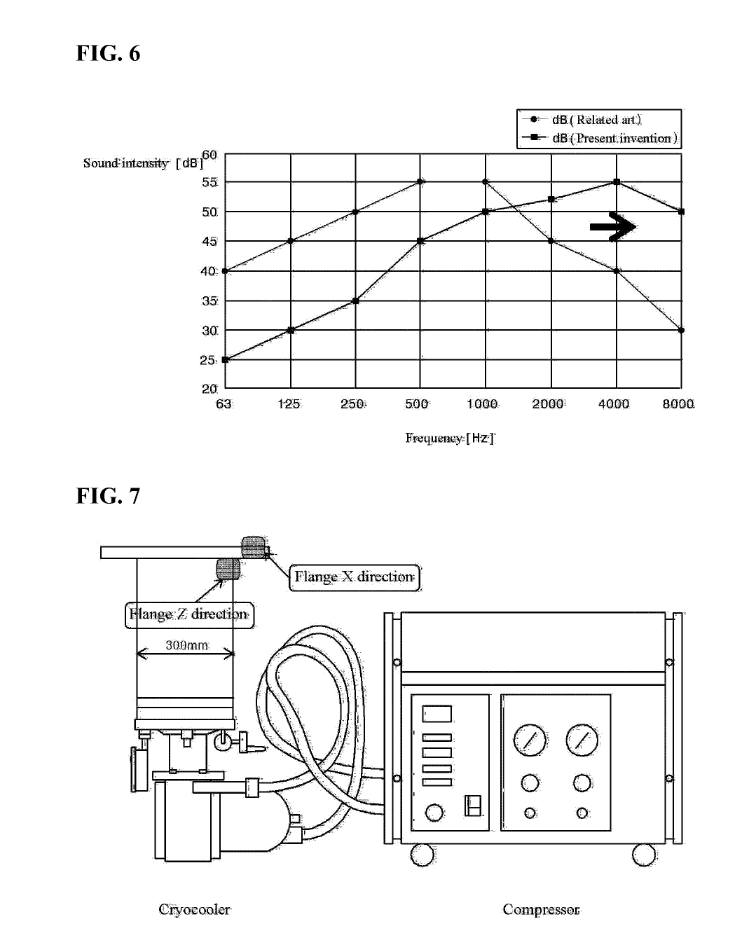

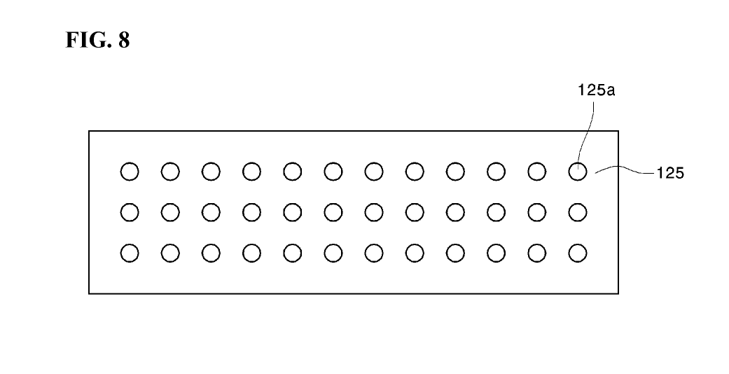

FIG. 2 shows a cryopump according to one embodiment of the disclosure. FIG. 3 shows a cryocooler according to one embodiment of the disclosure. FIG. 4 shows a state in which a refrigerant gas flows into a cylinder main body through an inlet valve in the cryocooler shown in FIG. 3. FIG. 5 shows a state in which the refrigerant gas flows out of the cylinder main body through an outlet valve in the cryocooler shown in FIG. 3. FIG. 6 is a graph showing sound intensity versus frequency for cryocoolers according to the related art and the embodiment of the disclosure. FIG. 7 shows sensor positions in vibration tests conducted in cryopumps according to the related art and the embodiment of the disclosure. FIG. 8 shows an inlet diffuser according to one embodiment of the disclosure.

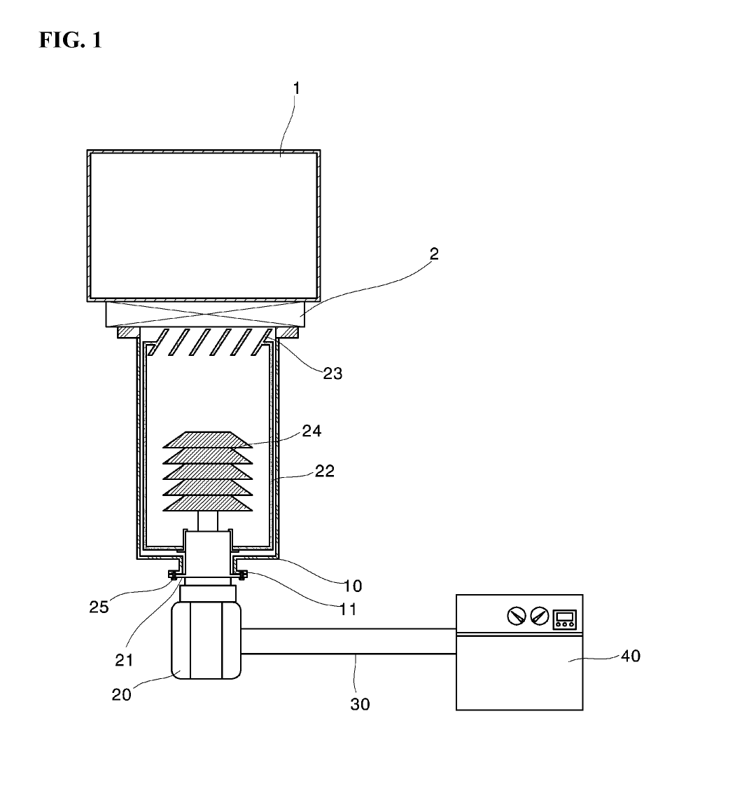

Referring to FIGS. 2 and 3, a cryopump 200 according to one embodiment of the disclosure may operate in the same or similar refrigeration cycle to the typical cryopump shown in FIG. 1. The cryopump is used to create a high to ultrahigh vacuum environment in a variety of industrial fields including semiconductor manufacturing. The cryopump decreases the inner temperature thereof to an absolute temperature of 8 K (about −265° C.) so that gas molecules lose momentum and thus are condensed or captured, thereby creating a vacuum.

For example, the cryopump may cool the inside thereof to a cryogenic temperature using the Stirling cycle, the Solvay cycle, or the Giffor-Macmahon (GM) refrigeration cycle, and hydrogen (H₂) or helium (He) may be used as a refrigerant.

The cryopump according to the embodiment of the disclosure includes a pump body 210 having a receiving space and a cryocooler 100 connected to the pump body 210 and producing cryogenic temperatures by expanding a refrigerant gas. The cryocooler 100 is connected to a compressor 240 through a hose 230. The compressor 240 supplies a high-pressure refrigerant gas to the cryocooler 100 and recompresses a low-pressure refrigerant gas returning from the cryocooler 100.

The cryocooler 100 may be connected to a first array 222 having a chamber shape, and a baffle 223 may be disposed at an upper end of the first array 222. A second array 224 connected to an upper end of the cryocooler 100 may be placed in the first array 222. Through repeated expansion of a refrigerant gas, the first array 222 may be maintained at a temperature of about 30 K to 100 K, and the second array 224 may be cooled to a temperature of 10 K to 30 K to condense or adsorb type II gases such as Ar, N₂, and O₂.

Through a gate valve 20, the pump body 210 may be connected to a process chamber 10 requiring a vacuum. With the gate valve 20 open, the cryopump can create a high to ultrahigh vacuum inside the process chamber 10.

Referring to FIGS. 2 and 3, the cryocooler 100 includes a cooler main body 10, a cylinder main body 150, a motor 115, a reciprocator 160, an inlet valve 120, an outlet valve 130, inlet diffusers 125, 126, outlet diffusers 135, 136, and a valve plate 140.

The cooler main body 100 has a receiving space in which various components may be received. The cooler main body 110 receives the motor 115, the inlet valve 120, and the outlet valve 130.

The cylinder main body 150 is connected to the cooler main body 100 and has a receiving space in which various components may be received. Although the cooler main body 110 and the cylinder main body 150 are formed as separate members in the embodiment, the cooler main body 110 may also be integrally formed with the cylinder main body 150.

The motor 115 is received in the cooler main body 110 and transmits power to move the reciprocator 160 linearly.

The reciprocator 160 is received in the cylinder main body 150 and connected to the motor 115 to move linearly by a rotary motion of the motor 115. The reciprocator 160 has a hollow space for receiving a cold storage material. Rotary motion of the motor 115 may be changed into linear motion by a power transmission mechanism such as a yoke 117 and transmitted to the reciprocator 160.

The compressor 240 produces a high-pressure refrigerant gas by compressing a refrigerant gas (e.g., helium gas). The produced high-pressure refrigerant gas is fed into the cylinder main body 150 through the inlet valve 120. In addition, a low-pressure refrigerant gas is discharged from the cylinder main body 150 through the outlet valve 130 and collected in the compressor 240.

The inlet valve 120 is received in the cooler main body 110 and connected to the compressor 240. The inlet valve 120 may be controlled to introduce a high-pressure refrigerant gas supplied from the compressor 240 into the cylinder main body 150. The high-pressure refrigerant gas supplied from the compressor 240 is fed into the cylinder main body 150 through a flow path formed in the cooler main body 110, and the inlet valve 120 is installed in the middle of the flow path. The high-pressure refrigerant gas causes vibration and noise when fed into the cylinder main body 150 through the inlet valve 120.

The inlet diffusers 125, 126 are disposed at a front or rear end of the inlet valve 120 to reduce noise and vibration when the refrigerant gas is fed into the cylinder main body 150. Here, the front and rear ends of the inlet valve 120 refer to a motor side and a cylinder main body side, respectively. The detachable inlet diffusers 125, 126 may be employed only when there is a need for low vibration/noise, thereby enhancing efficiency.

The inlet diffusers 125, 126 have a plurality of openings such that the high-pressure refrigerant gas to be fed into the cylinder main body 150 through the open inlet valve 120 may flow along numerous separated flow paths. The openings of the inlet diffusers 125, 126 have a diameter of 1 mm or less. Any types of inlet diffusers may be used to allow the refrigerant gas to flow along a plurality of separated flow paths. The inlet diffusers 125, 126 may have a shape with a plurality of openings, such as a mesh net, a sponge, or a scrubber.

The inlet diffusers 125, 126 separate a large fluid flow into many small fluid flows, each having a reduced potential core region and a predetermined jet. Therefore, the fluid flows are stabilized, thereby significantly reducing vibration, particularly, impulsive vibration. The inlet diffusers 125, 126 serve as a damper suitable for a supply line of a refrigerant gas and stabilize the refrigerant gas flow over a short distance between the reciprocator 160 and the inlet valve 120.

For example, the inlet diffusers 125, 126 may be formed of a mesh net having a plurality of openings 125a. The inlet diffusers 125, 126 may be formed of a mesh net of 80 to 250 mesh. Here, 80 mesh means that there are 80 holes in an area of 1 inch by 1 inch.

The outlet valve 130 is received in the cooler main body 110. The outlet valve 130 may be connected to the compressor 240 and controlled to discharge a low-pressure refrigerant gas expanded in the cylinder main body 150. The refrigerant gas discharged through the outlet valve 130 is collected in the compressor 240. The refrigerant gas discharged from the cylinder main body 150 is collected in the compressor 240 through a flow path formed in the cooler main body 110, and the outlet valve 130 is disposed in the middle of the flow path. The refrigerant gas causes vibration and noise when discharged from the cylinder main body 150 through the outlet valve 130.

The outlet diffusers 135, 136 are disposed at the front or rear end of the outlet valve 130 to reduce noise and vibration when the refrigerant gas is discharged from the cylinder main body 150. Here, the front and rear ends of the outlet valve 130 refer to a cylinder main body side and a motor side, respectively. The outlet diffusers 135, 136 may be disposed at one or both of the front and rear ends of the outlet valve 130.

The outlet diffusers 135, 136 have substantially the same configuration as the inlet diffusers 125, 126. The outlet diffusers 135, 136 have a plurality of openings such that the low-pressure refrigerant gas discharged from the cylinder main body 150 through the open outlet valve 130 may flow along numerous separated flow paths. The openings of the outlet diffusers 135, 136 have a diameter of 1 mm or less. Any types of outlet diffusers may be used to allow the refrigerant gas to flow along a plurality of separated flow paths.

For example, the outlet diffusers 135, 136 may be formed of a mesh net having a plurality of openings. The outlet diffusers 135, 136 may be formed of a mesh net of 80 to 250 mesh.

When the outlet valve 130 is open, the refrigerant gas is discharged while passing through the outlet diffusers 135, 136.

The valve plate 140 is disposed above the inlet and outlet diffusers 125, 135 and has a plurality of first and second openings 141, 142 allowing a refrigerant gas to flow into and out of the cylinder main body 150.

The second openings 142 may be five to thirty times as large as the openings formed in the inlet diffuser 125. The first openings 141 may be five to twenty times as large as the second openings 142. The first openings 141 may be formed to have a relatively large opening area such that a sufficient amount of refrigerant gas may flow therethrough, thus minimizing pressure loss of the refrigerant gas.

The number of second openings 142 may be ten to thirty times that of the second openings 142. The first and second openings 141, 142 separate the refrigerant gas flow having passed through the inlet diffusers 125, 126 into two groups, thereby additionally reducing noise and vibration.

The valve plate 140 has a recess 143 in which the inlet and outlet diffusers 125, 135 may be positioned. The recess 143 of the valve plate 140 provides a space in which the inlet and outlet diffusers 125, 135 may be positioned and prevents the inlet and outlet diffusers 125, 135 from separating from positions thereof by a refrigerant gas pressure. Reference numbers 170, 180, which are not described, denote first and second cooling stages, respectively.

Referring to FIG. 4, when the inlet valve 120 is open, a high-pressure refrigerant gas supplied from the compressor 240 passes through the inlet diffusers 125, 126 and the valve plate 140 and flows into the cylinder main body 150. At this time, the yoke 117 may move upward to lift the reciprocator 160 in the cylinder main body 150.

Referring to FIG. 5, when the outlet valve 130 is open, the refrigerant gas is discharged from the cylinder main body 150 through the valve plate 140 and the outlet diffusers 135, 136. At this time, the yoke 117 moves downward, and thus the reciprocator 160 closely approaches the bottom of the cylinder main body 150.

The inlet diffusers 125, 126 and the outlet diffusers 135, 136 separate the refrigerant gas flow into a plurality of small fluid flows to disperse energy of the refrigerant gas, thereby reducing overall vibration of the cryopump. In addition, the inlet diffusers 125, 126 and the outlet diffusers 135, 136 may convert low-frequency noise into high-frequency noise using the plural flow paths, thereby reducing audible noise.

A peak frequency is given by the following equation:

F=(S×W)/D

where F is frequency, S is the Strouhal number, W is speed, and D is a diameter of a flow path.

In the equation, S varies with pressure of the refrigerant gas, and W is related to a speed of the refrigerant gas having passed through the inlet valve 120. Therefore, when S and W have constant values, respectively, F (peak frequency) may increase with decreasing D.

A higher frequency sound is easily insulated by walls of the cooler main body 110 and the cylinder main body 150. Therefore, when plural flow paths are formed by the inlet diffuser 125, noise caused by a high-pressure refrigerant gas flowing into the cylinder main body 150 moves to a higher frequency band, thereby achieving a much greater sound insulation effect. In addition, more fluidically stable regions may be formed by reducing an expansion region of a refrigerant gas and uniformly distributing the refrigerant gas.

FIG. 6 is a graph showing a relationship between sound intensity and frequency of noises generated from the cryocoolers according to the related art and the embodiment of the disclosure. When the inlet diffuser 125 is employed for the cryocooler according to the embodiment of the disclosure, there is no large difference in noise between the cryocoolers; however, a peak frequency (F) is shifted to a frequency of 4000 Hz beyond the range of 500 to 1000 Hz in the related art. As the peak frequency of the noise is shifted to a higher frequency as described above, audible noise is further attenuated.

FIG. 7 shows positions of sensors in vibration tests conducted in 300 mm cryopumps according to the related art and the embodiment of the disclosure, and the sensors are attached to a flange in X and Z directions. The sensors attached to the flange in the X and Z directions measure horizontal and vertical vibrations, respectively.

Table 1 shows results obtained by conducting vibration tests in the related art and the disclosure.

TABLE 1
Cryopump (300 mm) Vibration test

| Sensor position | Item | Units | Related art | Disclosure | Related art:Disclosure |
|---|---|---|---|---|---|
| Flange Z | Amplitude | [g] | −0.40~0.30 | −0.20~0.20 | 2:1 |
| direction | | | | | |
| (Vertical) | | | | | |
| | Speed | [m/s] | −6.00~3.00 | −2.50~3.00 | — |
| | Displacement | [mm] | −0.10~0.10 | −0.03~0.02 | 5:1 |
| Flange X | Amplitude | [g] | −0.60~0.50 | −0.15~0.15 | 4:1 |
| direction | | | | | |
| (Horizontal) | | | | | |
| | Speed | [m/s] | −1.00~1.00 | −0.30~0.40 | 3:1 |
| | Displacement | [mm] | −0.02~0.02 | −0.02~0.02 | — |

From Table 1, it can be confirmed that, in the disclosure, the amplitude, speed, and displacement of vibration are all significantly decreased, as compared to the related art. The test results show that the cryopump according to the embodiment of the disclosure decreased noise by 6 dB and vibration by one third, as compared to the related art.

As described above, the cryocooler and the cryopump including the same according to the embodiments of the disclosure can reduce noise and vibration to a lower level than that of the typical cryopump, thereby satisfying process conditions required for manufacturing environments sensitive to vibration, such as semiconductor manufacturing, OLED manufacturing, implantation, and sputtering.

It will be apparent to those skilled in the art that the disclosure is not limited to the embodiments and various modifications or variations can be made without departing from the subject matters of the disclosure.

<List of Reference Numerals>

| | |
|---|---|
| 100: Cryocooler | 110: Cooler main body |
| 115: Motor | 117: Yoke |
| 120: Inlet valve | 125, 126: Inlet diffuser |
| 130: Outlet valve | 135, 136: Outlet diffuser |
| 140: Valve plate | 150: Cylinder main body |
| 160: Reciprocator | 170: First stage |
| 180: Second stage | 210: Pump body |
| 230: Hose | 240: Compressor |

1. A cryocooler for producing a cryogenic temperature by expanding a refrigerant gas, comprising:
a cooler main body having a receiving space;
a cylinder main body connected to the cooler main body and having a receiving space;
a motor received in the cooler main body;
a reciprocator received in the cylinder main body and connected to the motor to move linearly by a rotary motion of the motor;
an inlet valve received in the cooler main body and connected to a compressor to introduce a refrigerant gas into the cylinder main body;
an outlet valve received in the cooler main body and connected to the compressor to discharge the refrigerant gas from the cylinder main body; and
an inlet diffuser disposed at a front or rear end of the inlet valve and having a plurality of openings,
wherein the refrigerant gas is introduced into the cylinder main body through the inlet diffuser when the inlet valve is open, and the openings of the inlet diffuser have a diameter of 1 mm or less.

2. The cryocooler according to claim 1, further comprising:
an outlet diffuser disposed at the front or rear end of the outlet valve and having a plurality of openings,
wherein the refrigerant gas is discharged from the cylinder main body through the outlet diffuser when the outlet valve is open.

3. The cryocooler according to claim 1, wherein the inlet diffuser is formed of a mesh net of 80 to 250 mesh.

4. The cryocooler according to claim 1, further comprising:
a valve plate disposed above the inlet diffuser and having a plurality of openings allowing the refrigerant gas to flow into the cylinder main body therethrough,
wherein the openings of the valve plate are five to thirty times as large as those of the inlet diffuser.

5. The cryocooler according to claim 4, wherein the inlet diffuser is disposed in a recess formed in the valve plate.

6. A cryopump comprising:
the cryocooler according to claim 1;
a pump body having a receiving space and connected to the cryocooler; and
a compressor supplying a refrigerant gas to the cryocooler and recompressing the refrigerant gas returning from the cryocooler.
